(19) United States
(12) Patent Application Publication
(10) Pub. No.: US 2026/0191375 A1
(43) Pub. Date: Jul. 9, 2026

(54) SYSTEMS AND METHODS FOR ACTIVE SUSPENSION FOR A ROBOTIC VACUUM REMOVABLE CLEANING PAD

(71) Applicant: SharkNinja Operating LLC, Needham, MA (US)

(72) Inventor: Evan Paul Jasper, Whitman, MA (US)

(21) Appl. No.: 19/129,007

(22) PCT Filed: Nov. 10, 2023
(86) PCT No.: PCT/US2023/037168

§ 371 Date: May 10, 2025

Related U.S. Application Data
(60) Provisional application No. 63/424,754, filed on Nov. 11, 2022.
(60) Provisional application No. 63/424,740, filed on Nov. 11, 2022.
(60) Provisional application No. 63/532,266, filed on Aug. 11, 2023.
(60) Provisional application No. 63/532,269, filed on Aug. 11, 2023.

(51) Int. Cl. A47L 9/00; A47L 7/00; A47L 9/06; A47L 9/28; G05D 1/246; G05D 1/661; G05D 105/10

(52) U.S. Cl. CPC A47L 9/0063; A47L 7/0004; A47L 9/009; A47L 9/066; A47L 9/2826; A47L 9/2852; G05D 1/246; G05D 1/661; A47L 2201/02; G05D 2105/10

(57) ABSTRACT

A system and method may release or pick up a collecting body or cleaning pad from a robotic vacuum to selectively mop and/or vacuum a floor surface. A robotic vacuum base may include an attaching element protruding from the robotic vacuum base and a collecting body releasably coupled to the robotic vacuum. The collecting body may have an attaching element recess shaped to engage the attaching element. The attaching element recess may engage the attaching element to secure the collecting body to the robotic vacuum base in a direction of the robotic vacuum away from the robotic vacuum base.

### CROSS-REFERENCE TO RELATED APPLICATION

This application is a 35 U.S. C § 371 entry of PCT/US 2023/037168, filed Nov. 10, 2023, which claims the benefit of U.S. Provisional Application No. 63/424,754, filed Nov. 11, 2022; U.S. Provisional Application No. 63/424,740, filed Nov. 11, 2022; U.S. Provisional Application No. 63/532,266, filed Aug. 11, 2023 and U.S. Provisional Application No. 63/532,269, filed Aug. 11, 2023, the disclosures of which are incorporated by reference herein in their entirety.

### TECHNICAL FIELD

The present disclosure relates generally to the field of robotic vacuums and, more particularly, to a removable cleaning pad in a robotic vacuum.

### BACKGROUND

The background description provided herein is for the purpose of generally presenting the context of the disclosure. The work of the presently named inventors, to the extent it is described in this background section, as well as aspects of the description that may not otherwise qualify as prior art at the time of filing, are neither expressly nor impliedly admitted as prior art against the present disclosure.

Wet floor cleaning (“mopping”) in the home is labor intensive, time consuming, and often inefficient. Manually mopping typically involves a wet mop or sponge attached to a handle. A user applies cleaning fluid to the mop or sponge, then uses the handle to scrub the soiled area of the floor. Multiple iterations of fluid application and scrubbing may be required in some instances. Robotic vacuums may eliminate manual labor for mopping. One example of a robotic vacuum is described in U.S. patent application Ser. No. 16/893,811 “ROBOTIC CLEANER,” the disclosure of which is entirely incorporated by reference herein. A robotic vacuum mop may include a cleaning pad that may be impregnated with cleaning fluid to accomplish wet floor cleaning with or without vacuum assistance in addition to dry floor cleaning and vacuuming. The cleaning pad may be affixed to a floor-facing surface of the robotic vacuum. The vacuum may employ the cleaning pad when the vacuum detects debris on the floor that is most effectively removed by mopping rather than dry floor cleaning. For example, the vacuum may drag the cleaning pad over the debris area to pick up the debris or effectively transfer the debris from the floor to the cleaning pad. The vacuum may include one or more mechanisms to raise and lower the cleaning pad over the debris (e.g., active suspension, pad raising and lowering mechanism, etc.) or may cause the cleaning pad to contact the floor at all times during use.

Once the cleaning pad removes/transfers the debris to the cleaning pad, the vacuum may perform a variety of actions including 1) continuing its wet or dry cleaning actions on other floor areas, and 2) returning to its home base/charging dock. If the vacuum proceeds with action #1, the vacuum may encounter a floor area having a different height or varying heights than the area that was mopped by the cleaning pad (e.g., carpet). Here, the vacuum may sink down into the carpet or varying heights of this second floor area may inadvertently contact the underside of the vacuum and the cleaning pad. In this case, some of the debris that was transferred to the cleaning pad may be transferred to that higher floor area. If the vacuum proceeds with action #2, the robot may require manual intervention to remove or exchange the cleaning pad so that the vacuum may continue with a wet or dry cleaning process without accidental transfer of the debris to the higher or varying height floor area. Thus, there is a need for a robotic vacuum that can effectively mop debris from a first floor area without accidentally transferring the debris to a second floor area and without manual intervention.

### SUMMARY

The following presents a simplified summary of the present disclosure in order to provide a basic understanding of some aspects of the disclosure. This summary is not an extensive overview of the disclosure. It is not intended to identify key or critical elements of the disclosure or to delineate the scope of the disclosure. The following summary merely presents some concepts of the disclosure in a simplified form as a prelude to the more detailed description provided below.

In an embodiment, the disclosure describes a system for releasing a collecting body from a robotic vacuum. The system may include a robotic vacuum base including an attaching element protruding from the robotic vacuum base and a collecting body releasably coupled to the robotic vacuum. The collecting body may have an attaching element recess shaped to engage the attaching element. The attaching element recess may engage the attaching element to secure the collecting body to the robotic vacuum base in a direction of the robotic vacuum away from the robotic vacuum base. The robotic vacuum base may secure the attaching element and the attaching element may couple to an attaching element actuator to bias the attaching element away from the robotic vacuum base. Sliding movement of the collecting body of the robotic vacuum up and over the attaching element in a direction of the robotic vacuum toward the robotic vacuum base may further bias the attaching element actuator away from the robotic vacuum base and against the collecting body to thereby engage the attaching element within the attaching element recess. The attaching element and the attaching element actuator may form a detent. The collecting body may be a wet or dry cleaning pad.

### BRIEF DESCRIPTION OF THE DRAWINGS

Non-limiting and non-exhaustive embodiments are described in reference to the following drawings. The components in the figures are not necessarily to scale, emphasis instead being placed upon illustrating the principles of the disclosure. In the drawings, like reference numerals refer to like parts through all the various figures unless otherwise specified.

For a better understanding of the present disclosure, a reference will be made to the following detailed description, which is to be read in association with the accompanying drawings, wherein:

FIG. 1A is a partially cut-away side view of the cleaning robot and removable cleaning pad;

FIG. 1B is a front view of the cleaning robot;

FIG. 2 is a perspective view of the cleaning robot mated to a docking module of a vacuum base;

FIG. 3 is an illustration of the docking module;

FIGS. 4A, 4B, and 4C are illustrations of the cleaning robot entering and exiting the docking module to pick up or drop off a collecting body/cleaning pad;

FIG. 5 is a flow chart illustrating a method for employing the cleaning robot and removable cleaning pad in a “dry mode” of operation;

FIG. 6 is a flow chart illustrating a method for employing the cleaning robot and removable cleaning pad in a “wet mode” of operation; and

FIG. 7 is an illustration of a computing device for use with the cleaning robot and removable cleaning pad.

Persons of ordinary skill in the art will appreciate that elements in the figures are illustrated for simplicity and clarity so not all connections and options have been shown to avoid obscuring the inventive aspects. For example, common but well-understood elements that are useful or necessary in a commercially feasible embodiment are not often depicted in order to facilitate a less obstructed view of these various embodiments of the present disclosure. It will be further appreciated that certain actions and/or steps may be described or depicted in a particular order of occurrence while those skilled in the art will understand that such specificity with respect to sequence is not actually required. It will also be understood that the terms and expressions used herein are to be defined with respect to their corresponding respective areas of inquiry and study except where specific meaning have otherwise been set forth herein.

### DETAILED DESCRIPTION

The present disclosure now will be described more fully hereinafter with reference to the accompanying drawings, which form a part hereof, and which show, by way of illustration, specific exemplary embodiments by which the disclosure may be practiced. This disclosure may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment, or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, although it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and includes plural references. The meaning of “in” includes “in” and “on.”

The disclosure describes, in some embodiments, a releasable cleaning body (i.e., a cleaning pad, a wet and/or dry debris collecting bin, a scrubbing pad, a wet mopping pad, etc.) for an autonomous or semi-autonomous robot that may be configured to vacuum, wet clean, or otherwise clean floors, carpets, and/or other target surfaces in homes or other appropriate locations. In some embodiments, autonomous cleaning robots consistent with the disclosure may include a chassis and a transport drive system configured to autonomously transport cleaning elements over the target surface. The robot may be supported on the target surface by a plurality of wheels in rolling contact with the target surface, and the robot may include controls and drive elements configured to direct the robot to generally traverse the target surface in one or more directions. In some embodiments, the robot may include a drive device controlled by a controller and powered by one or more motors for performing autonomous movement over the target surface.

In some embodiments, the cleaning robot may include at least two separate cleaning modules. The cleaning modules may operate separately or in coordination. In some embodiments, the modular cleaning robot may include a dry cleaning module that may be configured to collect dry debris from the target surface and a wet cleaning module that may be configured to perform wet cleaning by applying a liquid, such as a cleaning fluid, onto a cleaning pad and using the cleaning pad to scrub the target surface. The surface cleaning robot may also include at least two containers or compartments that may store debris collected by the first cleaning module and to store cleaning fluid that may be used by the second cleaning module.

In some embodiments, the cleaning robot may include an active suspension system that may be configured to adjust the robot's ride height. The active suspension system may provide various benefits to the robot's performance, such as increased cleaning capabilities and efficiencies and improved energy efficiency and/or battery life. For example, in some embodiments, the active suspension system may help optimize ride height to improve suction/sealing with a target surface and/or to maintain desired contact with the target surface and rotation speeds for agitator brushes. Additionally, the active suspension system may provide improved mobility for the cleaning robot, such as by improving or optimizing ride height over target surfaces with varying properties and/or providing improved ability to travel over thresholds, cables, or other environmental obstacles. In some embodiments, the active suspension system may also provide for selectively lifting a cleaning body (or other robot features) to reduce or prevent the interference with the target surface when not desired. For example, in some embodiments, the active suspension system may provide for lifting a soiled cleaning body clear of a target surface, such as a rug, so as to reduce or eliminate transfer the soiling material to the target surface.

In some embodiments, the active suspension system described herein may provide hard stops to wheel modules of the robot that may allow the robot to vary ride height over different types of target surfaces. In some embodiments, this may be achieved without changing other features of the robot's suspension system. For example, in some embodiments, the active suspension system may provide tighter seals to certain types of target surfaces (e.g., bare floors, low-pile carpet, etc.) while still providing the ability to clear obstacles. In some embodiments, the target surface conditions may be determined by one or more sensors that may inform the optimal ride height for the given conditions and desired cleaning performance.

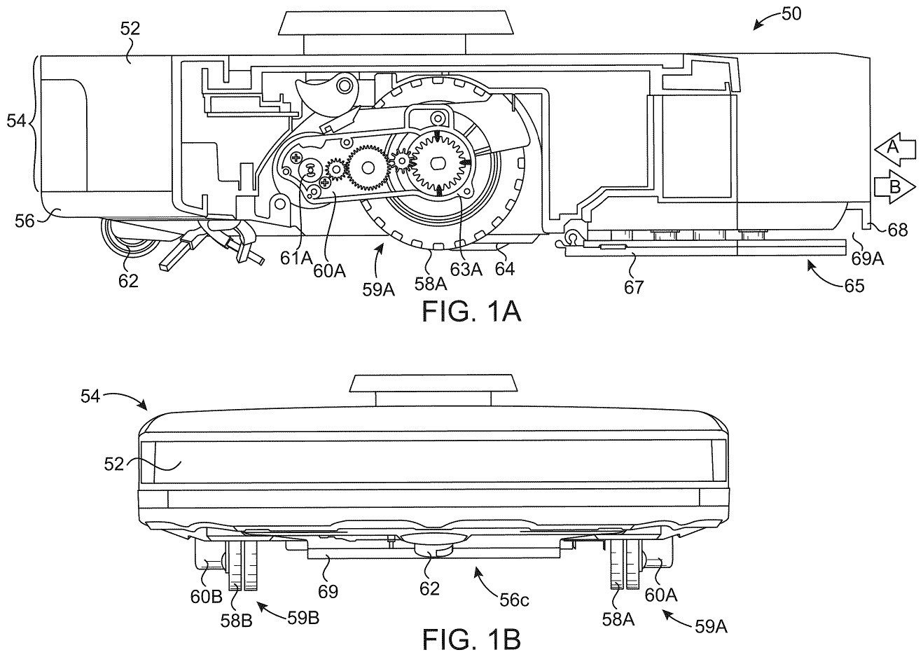

FIGS. 1A and 1B show an embodiment of a cleaning robot 50 that may include the active suspension system and releasable cleaning body described herein. The cleaning robot 50 may include a generally round housing or chassis 52 that may have an upper portion 54 and a lower portion 56. In some embodiments, the upper portion 54 may include a user interface that may be used to initiate cleaning or other operations and/or provide indications of robot status (e.g., mode, battery life, errors, etc.). The cleaning robot 50 may include one or more drive wheels 58A, 58B and one or more caster wheels 62 coupled to the lower portion 56 of the chassis 52. In some embodiments, the wheels 58A, 58B may be independently rotatable about associated rotational axes and may be coupled to a respective drive motor contained within a driven wheel assembly 59A, 59B. As such, in some embodiments, each wheel 58A, 58B may generally be described as being independently driven. In some embodiments, both wheels 58A, 58B may be driven with a single drive motor that may distribute power to the wheels 58A, 58B via one or more drive shafts and/or differentials. In some embodiments, the cleaning robot 50 may be autonomously steered or controlled to maneuver over a target surface such as by drive signals from a controller disposed on a control board on the robot. The drive signals may maneuver the cleaning robot by, for example, adjusting the rotational speed of one of the plurality of wheels (i.e., 58A or 58B) relative to the other of the plurality of wheels (i.e., 58A or 58B).

Each wheel assembly 59A, 59B may include an arm 60A, 60B and a wheel 58A, 58B rotatably coupled to the lower portion 56 of the chassis 52. Each arm 60A, 60B may have a corresponding proximate end. FIG. 1A shows only one proximate end 61A corresponding to arm 60A, however, arm 60B also includes a similar proximate end corresponding to arm 60B. Each wheel 58A, 58B may be rotatably coupled to a corresponding distal end. FIG. 1A shows only one distal end 63A corresponding to arm 60A, however, arm 60B also includes a similar distal end corresponding to arm 60B. In some embodiments, each wheel assembly 59A, 59B may include a drive motor that may be coupled to the arms 60A, 60B. In some embodiments, the wheel assembly may also include one or more gears that may be configured to transmit power from each drive motor to each respective wheel 58A, 58B. In some embodiments, each proximate end (e.g., 61A) of each respective arm 60A, 60B may be rotatable about the chassis 52 to raise and/or lower each respective wheel 58A, 58B. An active suspension system including at least the drive motor and wheel assemblies may cause each proximate end (e.g., 61A) of each respective arm 60A, 60B to rotate the thus selectively raise and/or lower the chassis 52 with respect to the floor or other target surface.

In some embodiments, the cleaning robot 50 may also include a vacuum module 64, which may include a suction conduit, a dust cup, and a suction motor. The suction conduit may be disposed on the lower portion 56 of the chassis 52 in opposed facing relationship to the floor or other target surface and may be fluidly coupled to the dust cup and the suction motor. In some embodiments, the suction motor may cause debris from the target surface to be suctioned into the suction conduit and deposited into the dust cup for later disposal. An air exhaust port may be fluidly coupled to the suction motor. In various embodiments, the air exhaust port may be configured to prevent undesirable debris agitation, to direct debris, or to dry cleaning fluid

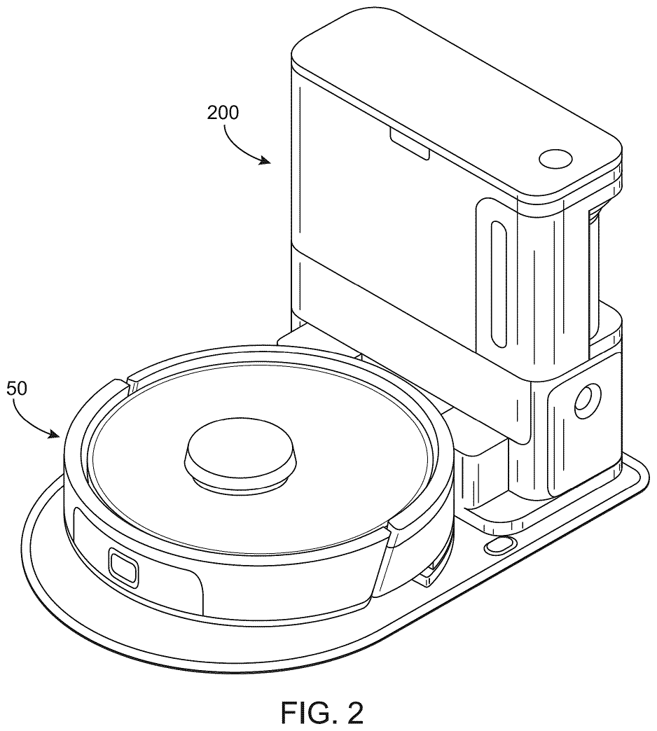

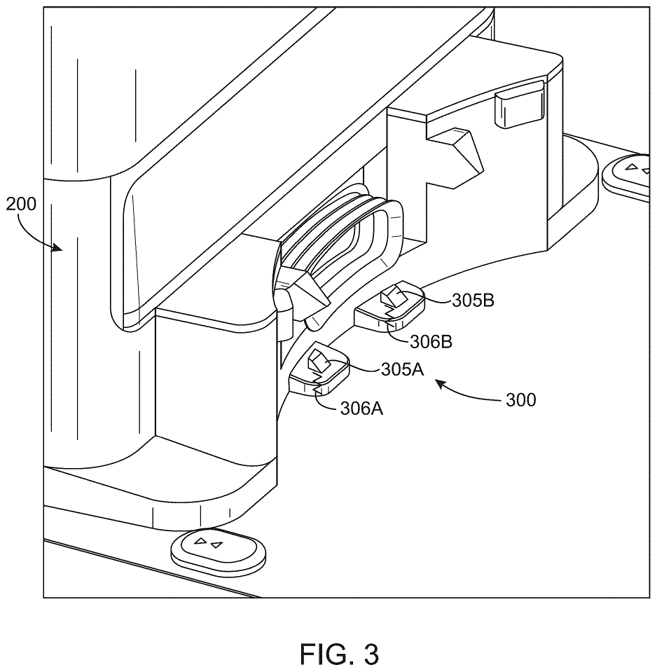

In some embodiments, the cleaning robot 50 may include a wet cleaning module 65 that may be removably affixed to the chassis 52. The wet cleaning module 65 may include a cleaning fluid tank and a collecting body (i.e., wet cleaning pad 67). In some embodiments, as the cleaning robot 50 may travel across a floor or other target surface, the suction conduit connected to the suction motor may collect dry debris from the floor while a liquid applicator of the wet cleaning module 65 may apply a cleaning fluid onto the wet cleaning pad 67. In some embodiments, the wet cleaning pad 67 may be raised and/or lowered with respect to the target surface, such as via the active suspension system 65. The wet cleaning module 65 may include an attachment device 68 for securing the cleaning body 67 to the cleaning module 65. In some embodiments, the attachment device 68 may slide between the cleaning body 67 and the wet cleaning module 65 to secure the cleaning body 67 to the wet cleaning module 65. For example, the attachment device 68 may include one or more sliding members that are received by one or more sliding member receivers (not shown) such as a cotter pin arrangement, a hair pin-type retainer, or other suitable device, as known in the art or as described herein. The attachment device 68 may be employed in cooperation with a robotic vacuum base (FIG. 2) generally and a docking module 300 (FIG. 3) in particular to pick up or drop off the cleaning body 67 when the cleaning robot 50 enters a “wet mode” or “dry mode” of operation, respectively, and as further described, below. The attachment device 68 may slidably engage the wet cleaning module 65 as indicated by arrow “A” of FIG. 1A to secure the cleaning body 67 to the wet cleaning module 65. The attachment device 68 may slidably disengage the wet cleaning module 65 as indicated by arrow “B” of FIG. 1A to release the cleaning body 67 from the wet cleaning module 65. The attachment device 68 may also include one or more attaching element recesses (e.g., 69A) that may be shaped to receive attaching elements 305A, 305B (FIG. 3) of the docking module 300. While FIG. 1A shows only one recess 69A, some embodiments may include one or more recesses to receive the attaching elements 305A, 305B. When so configured, cooperation of the attaching element recesses (e.g., 69A) and the attaching elements 305A, 305B during movement of the cleaning robot 50 along the direction of arrow “A” will hold the attachment device 68 in place and release the collecting body 67 to a robotic vacuum base 200 (FIG. 2).

FIG. 2 shows an embodiment of the cleaning robot 50 including a robotic vacuum base 200 in a docked configuration.

FIG. 3 shows a docking module 300 of the robotic vacuum base 200. The docking module 300 may be shaped to receive a rear portion of the cleaning robot 50 chassis 52. The docking module 300 may secure one or more attaching elements 305A, 305B that protrude outward from the docking module 300. In some embodiments, the attaching elements 305A, 305B are each coupled to an attaching element actuator 306A, 306B such that, in cooperation, they form a detent. For example, in embodiments where the attaching elements/actuators are configured as detents, each attaching element actuator 305A, 305B may bias the attaching elements 305A, 305B upward and away from the robotic vacuum base 200 while being secured by the docking module 300.

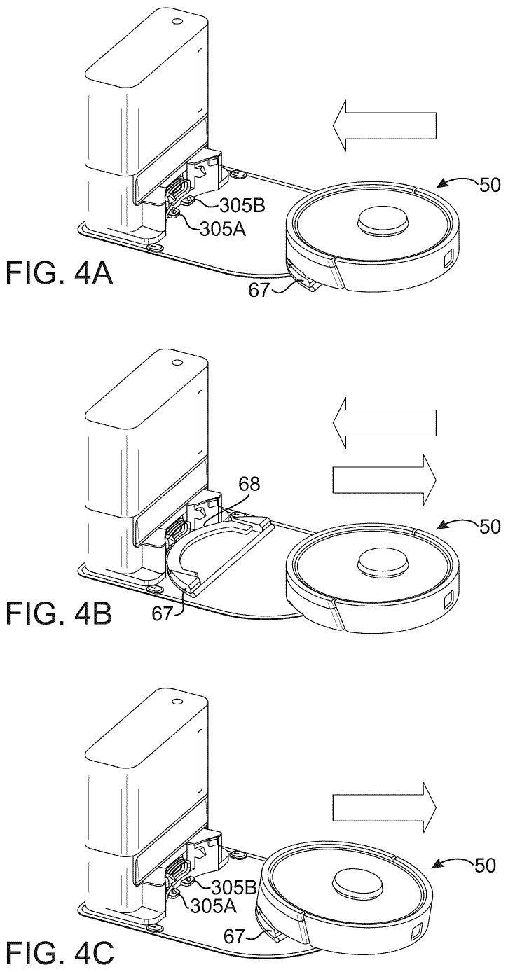

FIG. 4A may illustrate cleaning robot 50 entering the docking module 300 to drop off the collecting body/cleaning pad 67 and begin a “dry mode” of operation. A first face of each attaching element 305A, 305B that faces outward or away from the docking module 300 may be angular or ramp-like. In cooperation with a corresponding attaching element recess (e.g., 69A) the collecting body or cleaning pad 67 may slide up and over the attaching elements 305A, 305B as the cleaning robot 50 carrying the pad 67 moves toward the base 200. The weight of the cleaning robot 50 chassis 52 may compress a corresponding attaching element actuator 306A, 306B to further bias the attaching elements 305A, 305B against the pad 67 and/or chassis 55. Upon sliding to reach an attaching element recess (e.g., 69A) each attaching element 305A, 305B may engage a corresponding recess. A second face of each attaching element 305A, 305B that faces inward or toward the docking module 300 may be flat or otherwise shaped such that, in cooperation with the corresponding attaching element recess (e.g., 69A), the attachment device 68 may be held by cooperation between one or more attaching element recesses (e.g., 69A) and the attaching elements 305A, 305B as the cleaning robot 50 carrying the pad 67 moves away from base 200. By having the cleaning robot 50 carry the pad 67 away from the attachment device 68 that is now attached to the base 200, the attachment device 68 is now in a disengaged position with respect to the cleaning robot 50 to allow pad 67 to be left behind by cleaning robot 50, as shown by FIG. 4B, to begin a “dry mode” of operation.

FIG. 4B may also illustrate the cleaning robot 50 entering the docking module 300 to pick up the cleaning pad 67 and begin a “wet mode” of operation. Upon entering the docking module 300, the collecting body 67 may slidably engage the chassis 52 of the cleaning robot 50 to become secured to the chassis 52 by an attachment device 68 such as a lever latch that engages the chassis 52. FIG. 4C may illustrate the cleaning robot 50 leaving the docking module 300 in “wet mode” operation after the collecting body 67 is secured to the chassis 52. When the cleaning robot 50 leaves the docking module 300 in “wet mode,” it may use the active suspension system 65 to raise the chassis 52 with respect to the docking module 300 to bring each attaching element recess (e.g., 69A) up and over the attaching elements 305A, 305B on the docking module 300. In this way, the cleaning robot 50 may not need to electronically communicate with the docking module 300 and the docking module may not require extra electronics.

In embodiments of the cleaning robot 50 that include an active suspension system 65, one or more controllers disposed on the wheel assembly 59, the chassis 52, or elsewhere may be in electronic communication with the active suspension system 65 to provide instructions to alter the ride height of the cleaning robot 50 using the active suspension system 65. In cooperation with the docking module 300, the controller may determine a desired chassis clearance height in response to sensory inputs from the cleaning robot's 50 sensors about the docking module 300 or characteristics of other robot components (e.g., current draw, rate of rotation, etc.). For example, a 3D camera or other sensor may identify docking module 300 on a target surface where the cleaning robot 50 is cleaning or otherwise traveling. The 3D camera may transmit visual data related to the docking module 300 to the controller (e.g., laser point cloud make up, etc.), and the controller may decipher the visual data to determine a height of the obstacle with respect to the docking module 300. Based on the determined height of the docking module 300, the controller may determine a desired chassis clearance height that may allow the chassis 52 to clear the docking module 300 with the collecting body/cleaning pad 67 attached or otherwise configure the cleaning robot 50 for “wet mode” or “dry mode.” In some embodiments, based predetermined data for the active suspension system 65 (e.g., reference tables), the controller may then determine what degree of rotation for the arms 60A, 60B may result in the desired clearance height, if any. In response, the controller may transmit instructions to the active suspension system 65 to apply the determined degree of rotation that results in the desired clearance height. In some embodiments, this process may be iteratively repeated as additional obstacles are encountered and/or the robot 50 moves through its environment.

In addition, the controller may employ machine learning or artificial intelligence to use past events, such as docking events or traveling over specific wires, to learn a height that does not result in interference but results in suction and cleaning. The machine learning may occur locally or the input data such as visual data or roller motor current draw may be communicated to a remote central server where items previously encountered by other robots in different locations may be used to teach the robot in use a height that will be acceptable to avoid interference but result in acceptable cleaning.

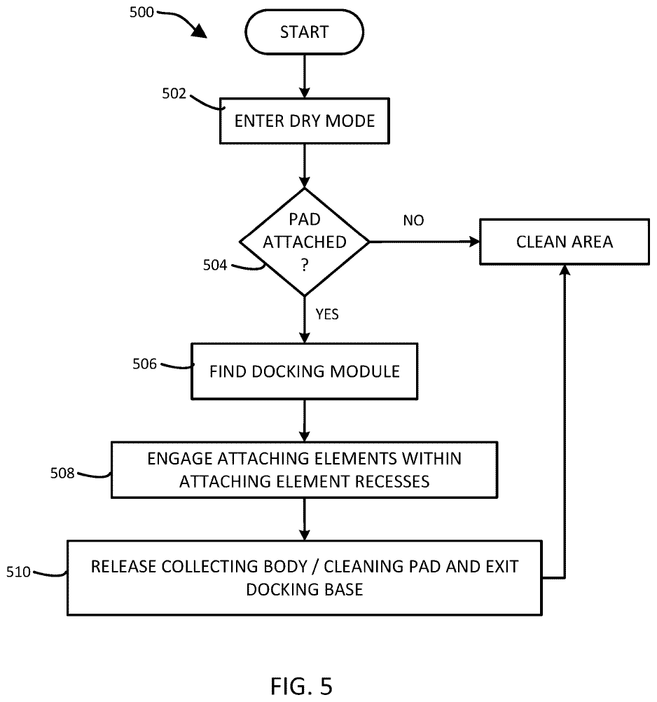

FIG. 5 is a flow chart of an embodiment of a method 500 of detaching a cleaning robot's collecting body/cleaning pad 67 for the cleaning robot to enter a “dry mode” of operation. At 502, the robot's controller may receive data to enter a “dry mode” of operation. At 504, the controller may receive data indicating whether the collecting body or cleaning pad 67 is attached. If it is not attached, the cleaning robot 50 may begin a “dry mode” of operation and clean the area. If it is attached, then, at 506, the controller may execute instructions to find the docking module 300. The instructions to find the docking module 300 may include a stored map to the module 300, sensing a beacon of the module 300 to guide the cleaning robot 50, or other method to find the module 300. Once the docking module 300 is found, at 508, the controller may receive instructions to cause the cleaning robot 50 to back into the docking module 300 and drop off the collecting body/cleaning pad 67. In some embodiments, the chassis 52 generally and the collecting body/cleaning pad 67 in particular may slide over the attaching elements 305A, 305B of the docking module 300 to engage the attaching elements 305A, 305B within the attaching element recess (e.g., 69A). Engagement of the attaching elements 305A, 305B within the attaching element recesses (e.g., 69A) secures the collecting body/cleaning pad 67 to the docking base.

At 510, the controller may communicate with a drive system of the cleaning robot 50 for the cleaning robot to leave the docking module 300 while the attaching elements 305A, 305B are engaged within the attaching element recesses (e.g., 69A). Motion of the cleaning robot 50 away from the docking module 300 (i.e., a direction of arrow “B” of FIG. 4B) may activate the attachment device 68 and disengage the cleaning body 67 from the chassis 52. The cleaning robot 50 may then drive away from the docking module 300 to begin the “dry mode” cleaning process.

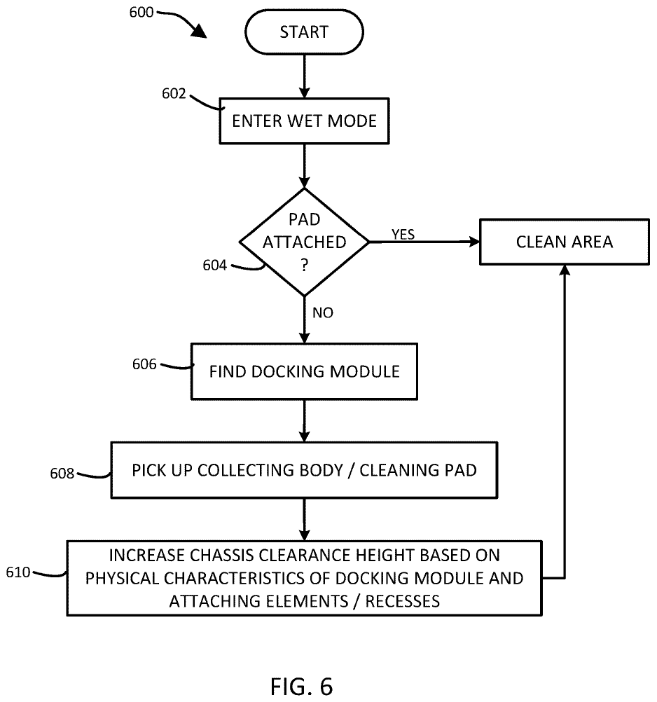

FIG. 6 is a flow chart of an embodiment of a method 600 of attaching a cleaning robot's collecting body/cleaning pad 67 for the cleaning robot to enter a “wet mode” of operation. At 602, the robot's controller may receive data to enter a “wet mode” of operation. At 604, the controller may receive data indicating whether the collecting body or cleaning pad 67 is attached. If it is attached, the cleaning robot 50 may begin a “wet mode” of operation and clean the area. If it is not attached, then, at 606, the controller may execute instructions to find the docking module 300. The instructions to find the docking module 300 may include a stored map to the module 300, sensing a beacon of the module 300 to guide the cleaning robot 50, or other method to find the module 300. Once the docking module 300 is found, at 608, the controller may receive instructions to cause the cleaning robot 50 to back into the docking module 300 and pick up the collecting body/cleaning pad 67. In some embodiments, the chassis 52 may engage the collecting body/cleaning pad with an attachment device 68 (FIG. 4B).

At 610, the controller may communicate with the active suspension system 65 to achieve the desired chassis clearance height to clear attaching elements 305A, 305B from the attaching element recess (e.g., 69A) of the attachment device 68 and drive away from the docking module 300 with the cleaning body 67 attached to the chassis 52 to begin the “wet mode” cleaning process.

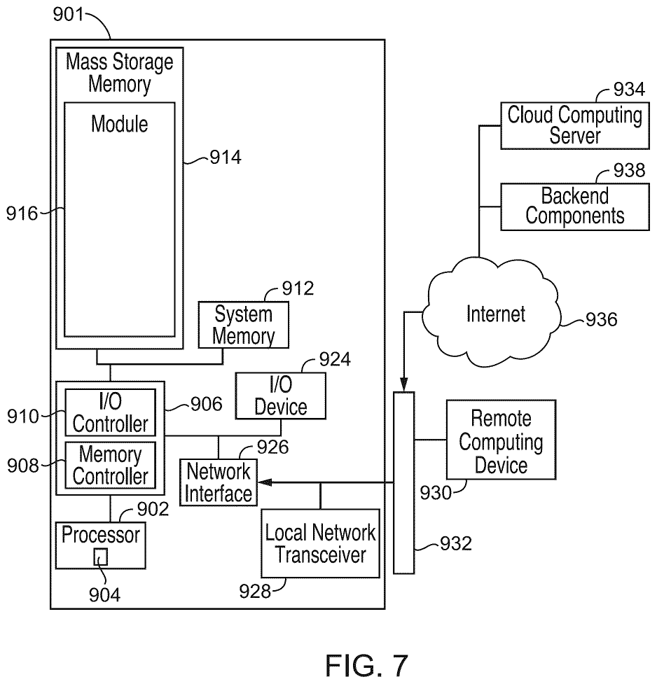

As described above, computing devices may be used by the cleaning robot 50. FIG. 7 may illustrate a sample computing device 901. The computing device 901 includes a controller or processor 902 that is coupled to an interconnection bus. The processor 902 includes a register set or register space 904, which is depicted in FIG. 7 as being entirely on-chip, but which could alternatively be located entirely or partially off-chip and directly coupled to the processor 902 via dedicated electrical connections and/or via the interconnection bus. The processor 902 may be any suitable processor, processing unit or microprocessor. Although not shown in FIG. 7, the computing device 901 may be a multi-processor device and, thus, may include one or more additional processors that are identical or similar to the processor 902 and that are communicatively coupled to the interconnection bus.

The processor 902 of FIG. 7 is coupled to a chipset 906, which includes a memory controller 908 and a peripheral input/output (I/O) controller 910. As is well known, a chipset typically provides I/O and memory management functions as well as a plurality of general purpose and/or special purpose registers, timers, etc. that are accessible or used by one or more processors coupled to the chipset 906. The memory controller 908 performs functions that enable the processor 902 (or processors if there are multiple processors) to access a system memory 912 and a mass storage memory 914, that may include either or both of an in-memory cache (e.g., a cache within the memory 912) or an on-disk cache (e.g., a cache within the mass storage memory 914).

The system memory 912 may include any desired type of volatile and/or non-volatile memory such as, for example, static random access memory (SRAM), dynamic random access memory (DRAM), flash memory, read-only memory (ROM), etc. The mass storage memory 914 may include any desired type of mass storage device. For example, the computing device 901 may be used to implement a module 916 (e.g., the various modules as herein described such as those performing the methods 500 and 600). The mass storage memory 914 may include a hard disk drive, an optical drive, a tape storage device, a solid-state memory (e.g., a flash memory, a RAM memory, etc.), a magnetic memory (e.g., a hard drive), or any other memory suitable for mass storage. As used herein, the terms module, block, function, operation, procedure, routine, step, and method refer to tangible computer program logic or tangible computer executable instructions that provide the specified functionality to the computing device 901, the systems and methods described herein. Thus, a module, block, function, operation, procedure, routine, step, and method can be implemented in hardware, firmware, and/or software. In one embodiment, program modules and routines are stored in mass storage memory 914, loaded into system memory 912, and executed by a processor 902 or can be provided from computer program products that are stored in tangible computer-readable storage mediums (e.g. RAM, hard disk, optical/magnetic media, etc.).

The peripheral I/O controller 910 performs functions that enable the processor 902 to communicate with a peripheral input/output (I/O) device 924, a network interface 926, a local network transceiver 928, (via the network interface 926) via a peripheral I/O bus. The I/O device 924 may be any desired type of I/O device such as, for example, a keyboard, a display (e.g., a liquid crystal display (LCD), a cathode ray tube (CRT) display, etc.), a navigation device (e.g., a mouse, a trackball, a capacitive touch pad, a joystick, etc.), etc. The I/O device 924 may be used with the module 916, etc., to receive data from the transceiver 928, send the data to the components of the system 100, and perform any operations related to the methods as described herein. The local network transceiver 928 may include support for a Wi-Fi network, Bluetooth, Infrared, cellular, or other wireless data transmission protocols. In other embodiments, one element may simultaneously support each of the various wireless protocols employed by the computing device 901. For example, a software-defined radio may be able to support multiple protocols via downloadable instructions. In operation, the computing device 901 may be able to periodically poll for visible wireless network transmitters (both cellular and local network) on a periodic basis. Such polling may be possible even while normal wireless traffic is being supported on the computing device 901. The network interface 926 may be, for example, an Ethernet device, an asynchronous transfer mode (ATM) device, an 802.11 wireless interface device, a DSL modem, a cable modem, a cellular modem, etc., that enables the system 100 to communicate with another computer system having at least the elements described in relation to the system 100.

While the memory controller 908 and the I/O controller 910 are depicted in FIG. 7 as separate functional blocks within the chipset 906, the functions performed by these blocks may be integrated within a single integrated circuit or may be implemented using two or more separate integrated circuits. The computing environment 900 may also implement the module 916 on a remote computing device 930. The remote computing device 930 may communicate with the computing device 901 over an Ethernet link 932. In some embodiments, the module 916 may be retrieved by the computing device 901 from a cloud computing server 934 via the Internet 936. When using the cloud computing server 934, the retrieved module 916 may be programmatically linked with the computing device 901. The module 916 may be a collection of various software platforms including artificial intelligence software and document creation software or may also be a Java® applet executing within a Java® Virtual Machine (JVM) environment resident in the computing device 901 or the remote computing device 930. The module 916 may also be a “plug-in” adapted to execute in a web-browser located on the computing devices 901 and 930. In some embodiments, the module 916 may communicate with back end components 938 via the Internet 936.

The system 900 may include but is not limited to any combination of a LAN, a MAN, a WAN, a mobile, a wired or wireless network, a private network, or a virtual private network. Moreover, while only one remote computing device 930 is illustrated in FIG. 6 to simplify and clarify the description, it is understood that any number of client computers are supported and can be in communication within the system 900.

Additionally, certain embodiments are described herein as including logic or a number of components, modules, or mechanisms. Modules may constitute either software modules (e.g., code or instructions embodied on a machine-readable medium or in a transmission signal, wherein the code is executed by a processor) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments” or “an embodiment” or “teaching” means that a particular element, feature, structure, or characteristic described in connection with the embodiment is included in at least one embodiment. The appearances of the phrase “in some embodiments” or “teachings” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

Further, the figures depict preferred embodiments for purposes of illustration only. One skilled in the art will readily recognize from the following discussion that alternative embodiments of the structures and methods illustrated herein may be employed without departing from the principles described herein

Upon reading this disclosure, those of skill in the art will appreciate still additional alternative structural and functional designs for the systems and methods described herein through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the systems and methods disclosed herein without departing from the spirit and scope defined in any appended claims.

The foregoing description and drawings merely explain and illustrate the invention and the invention is not limited thereto. While the specification is described in relation to certain implementation or embodiments, many details are set forth for the purpose of illustration. Thus, the foregoing merely illustrates the principles of the invention. For example, the invention may have other specific forms without departing from its spirit or essential characteristic. The described arrangements are illustrative and not restrictive. To those skilled in the art, the invention is susceptible to additional implementations or embodiments and certain of these details described in this application may be varied considerably without departing from the basic principles of the invention. It will thus be appreciated that those skilled in the art will be able to devise various arrangements which, although not explicitly described or shown herein, embody the principles of the invention and, thus, within its scope and spirit.

What is claimed is:

1. A system for releasing a collecting body from a robotic vacuum to convert the robotic vacuum to a dry mode of operation when the robotic vacuum is configured for a wet mode of operation, the system comprising:
a robotic vacuum base including an attaching element protruding from the robotic vacuum base; and
a collecting body releasably coupled to the robotic vacuum by an attachment device engaging the robotic vacuum between the collecting body and the robotic vacuum, the attachment device having an attaching element recess shaped to engage the attaching element of the robotic vacuum base;
wherein the attaching element recess engaging the attaching element releases the collecting body from the robotic vacuum base in a direction of the robotic vacuum away from the robotic vacuum base.

2. The system of claim 1, wherein the robotic vacuum base secures the attaching element and the attaching element is coupled to an attaching element actuator to bias the attaching element away from the robotic vacuum base.

3. The system of claim 2, wherein sliding movement of the attachment device up and over the attaching element in a direction of the robotic vacuum toward the robotic vacuum base compresses the attaching element actuator and further biases the attaching element against the attachment device to engage the attaching element within the attaching element recess.

4. The system of claim 1, wherein the attaching element and the attaching element actuator form a detent.

5. The system of claim 1, wherein the collecting body is a cleaning pad.

6. The system of claim 1, further comprising:
a robotic vacuum chassis of the robotic vacuum including an upper portion and a lower portion;
one or more wheel assemblies disposed on the lower portion of the chassis, each of the one or more wheel assemblies including:
an arm having a first end pivotally mounted to the chassis and a second end opposite the first end;
a wheel rotatably coupled to the second end of the arm, the wheel configured to contact a target surface;
one or more sensors configured to determine characteristics of a first floor area of the target surface and a second floor area of the target surface; and
an active suspension system configured to rotate the arm about the first end in response to the one or more sensors determining characteristics of the second floor area while the robotic vacuum is at least partially within the first floor area.

7. The system of claim 6, wherein the active suspension system is further configured to adjust one or more ride height dimensions of the robotic vacuum in response to the one or more sensors determining characteristics of the second floor area while the robotic vacuum is at least partially within the first floor area to thereby lift the collecting body above the second floor area.

8. A method for converting a robotic vacuum to a dry mode of operation when the robotic vacuum is configured for a wet mode of operation, the method comprising:
receiving processor-executable instructions to enter a dry mode of operation at the robotic vacuum;
in response to receiving processor-executable instructions to enter the dry mode of operation at the robotic vacuum, executing processor-executable instructions for:
determining a wet mode cleaning body is attached to a chassis of the robotic vacuum;
locating a docking module of the robotic vacuum; and
engaging an attaching element of the docking module within an attaching element recess of the wet mode cleaning body;
wherein engagement of the attaching element of the docking module within the attaching element recess of the wet mode cleaning body disengages the wet mode cleaning body from the robotic vacuum when the robotic vacuum drives away from the docking module.

9. The method of claim 8, wherein the processor-executable instructions for locating the docking module of the robotic vacuum include one or more of accessing a stored map to the docking module and sensing a beacon of the docking module.

10. The method of claim 8, wherein engaging the attaching element of the docking module within the attaching element recess of the wet mode cleaning body includes sliding an attachment device of the robotic vacuum up and over the attaching element in a direction of the robotic vacuum toward the robotic vacuum base to thereby compress an attaching element actuator and bias the attaching element against the attachment device and engage the attaching element within the attaching element recess.

11. The method of claim 8, wherein receiving processor-executable instructions to enter the dry mode of operation at the robotic vacuum includes determining characteristics of a second floor area while the robotic vacuum is at least partially within a first floor area.

12. The method of claim 11, further comprising adjusting one or more ride height dimensions of the robotic vacuum in response to the one or more sensors determining characteristics of the second floor area while the robotic vacuum is at least partially within the first floor area to thereby lift the collecting body above the second floor area.

13. The method of claim 12, wherein the second floor area consists of a carpet.

14. The method of claim 12, wherein adjusting one or more ride height dimensions of the robotic vacuum includes rotating one or more wheel assemblies of the robotic vacuum to lift the cleaning body above the second floor area.

15. The method of claim 14, wherein the one or more wheel assemblies each include an arm and a wheel rotatably coupled to the chassis.
